(19) United States
(12) Patent Application Publication
(10) Pub. No.: US 2004/0009055 A1
(43) Pub. Date: Jan. 15, 2004

(54) Tilting ramp for transport of personal recreational vehicles

(76) Inventor: Jerry A. Scherle, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/438,020

(22) Filed: May 15, 2003

Related U.S. Application Data
(63) Continuation-in-part of application No. 09/816,461, filed on Mar. 26, 2001, now abandoned.

(51) Int. Cl. B60P 1/00

(52) U.S. Cl. 414/537

(57) ABSTRACT

A tilting ramp is for mounting to a truck, and once so mounted for loading, unloading and transport of at least one personal recreational vehicle. The ramp is slidable over a bed of the truck. A pivot member is mounted into a receiver tube mounted to the truck. The pivot member extends upwardly into translational engagement with the ramp. The ramp may be translated over both the bed and the pivot member between a transport position forward on the bed and a pivoting position pivotable about the pivot member. In the pivoting position the ramp is pivotable between the horizontal and an inclined position in engagement with the ground surface.

### CROSS REFERENCE TO RELATED APPLICATION

This application is a Continuation-in-Part of U.S. patent application Ser. No. 09/816,461 filed Mar. 26, 2001 entitled Tilting Ramp for Transport of Personal Recreational Vehicles.

### FIELD OF THE INVENTION

This invention relates to the field of ramps for loading personal recreational vehicles onto transports such as pickup trucks and in particular to a tilting ramp for transport of personal recreational vehicles which is mountable to the transport by the use of the transport's receiver hitch tube.

### BACKGROUND OF THE INVENTION

In the prior art, applicant is aware of numerous devices in the form of ramps or the like which may be deployed from a transport so as to ease loading of a load-carrying bed of the transport, and in particular, the loading of personal recreational vehicles such as snowmobiles.

For example, applicant is aware of U.S. Pat. No. 3,687,314 which issued to Haugland on Aug. 29, 1972 for a Device For Loading A Snowmobile On To A Truck. The device is of two sections, the sections hinged to one another. One section has wheels and runs along the length of the bed of a truck, the other section is a ramp section which, when the wheeled section is resting on the tailgate or floor of the bed of the truck, may be lowered from the horizontal so that its rearward end touches the ground. A snowmobile may then be driven on to the ramp section and the ramp section then elevated to the horizontal and both sections slid forwardly on to the truck bed. An anchor cable is provided to prevent the wheeled section from rolling off the rearward end of the truck bed.

Applicant is also aware of three laid-open Canadian patent applications and in particular Application No. 2,076,255 entitled Vehicle Attachment For Transporting Snowmobiles filed by Alexander and laid open Feb. 18, 1994, Application No. 2,079,170 entitled Loading/Unloading Apparatus filed by Stanley and laid open Mar. 26, 1994, and Application No. 2,134,482 entitled Snowmobile Carrier filed by Bronstein et al. and laid open Apr. 28, 1996.

Alexander teaches a snowmobile-supporting frame mountable into the bed of a truck so as to carry snowmobiles on a platform which is pivotally mounted on to the frame above the upper edges of the sides of the truck bed. The platform is rotatable so as to turn the snowmobiles for ease of unloading down a detachable ramp which may be connected to either the front or rear of the platform.

Stanley discloses a tilting, slide-out deck which runs on rollers on the bed of a pickup truck. The rollers are secured to the truck bed and engaged by runners on the deck. The runners are hinged medially along their lengths so that as the deck is pulled out the rearward portion of the runners hinge downwardly, a ramp extension sliding out from a stowed position in the deck so as to engage the ground for loading.

Bronstein et al teach a tiltable and rotatable snowmobile carrier for carrying snowmobiles elevated above the sides of a pickup truck box wherein the frame carrying the snowmobiles once pivoted to orient a snowmobile for unloading, is inclined so as to cooperate with a ramp which is removably mounted in the base of the frame for releasable mounting to the rear end of the base.

### SUMMARY OF THE INVENTION

The tilting ramp of the present invention is for mounting to a truck, and once so mounted, for loading, unloading and transport of at least one personal recreational vehicle. The ramp is slidable over a bed of the truck. A pivot member is mounted into a receiver tube mounted to the truck. The pivot member extends upwardly into translational engagement with the ramp. The ramp may be translated over both the bed and the pivot member between a transport position forward on the bed and a pivoting position pivotable about the pivot member. In the pivoting position the ramp is pivotable between the horizontal and an inclined position in engagement with the ground surface.

The pivot member includes a mating portion such as one end of a cantilevered mounting member for cantilevered mating into the receiver tube, a riser portion rigidly upwardly extending from, and mounted to, the mating portion, and a pivot mounted atop the riser portion.

In one embodiment, the translational engagement of the pivot member with the ramp is rolling cooperation therebetween of at least one roller mounted between the pivot and a corresponding longitudinal member of the ramp.

The ramp may be planar and have a plurality of longitudinal members extending between opposite front and rear ends of the ramp. The longitudinal members may depend downwardly from the ramp.

The ramp may also include means such as wheels or slides, or rollers or other translation means for sliding the front end of the ramp over the load receiving bed. When a personal recreational vehicle is parked on the ramp, the combined center of gravity of the vehicle and the ramp is proximate to the pivot to assist in ease of raising or lowering the loaded ramp about the pivot. The pivot may be at least one pivotable roller mount pivotally mounted atop the riser portion. The riser portion may include a post and a cross-bar rigidly mounted atop the post. The longitudinal members may be a parallel pair of laterally spaced apart longitudinal members in which case a pair of pivotable roller mounts are provided spaced apart along the cross-bar and correspondingly positioned to the pair of longitudinal members. Rollers may be mounted to the roller mounts so that the longitudinal members ride on the rollers.

The longitudinal members may each have a spaced array of first apertures. The roller mounts may be elongate in a longitudinal direction and have second apertures for pinned or latched or other means of releasable locking of the roller mounts to the longitudinal members for example by pins insertable through aligned first and second apertures.

### BRIEF DESCRIPTION OF THE DRAWINGS

FIG. 1 is, in side elevation view, the ramp of the present invention inclined for loading or unloading.

FIG. 2 is, in side elevation view, the ramp of FIG. 1 being elevated during loading.

FIG. 3 is, in side elevation view, the ramp of FIG. 2 being rolled into the box of a pickup truck.

FIG. 4 is, in side elevation view, the ramp of FIG. 3 locked in place for transportation.

FIG. 4a is, in enlarged partially cut-away view, the hitch mounted ramp trolley according to the present invention.

FIG. 5 is, in side elevation enlarged view, the ramp and pivoting trolley of FIG. 4.

FIG. 6 is, in top perspective view, the ramp and pivoting trolley of FIG. 5.

FIG. 6a is, in partially cut-away enlarged view, the pivoting trolley of FIG. 6.

FIG. 7 is, in bottom perspective view, the ramp and pivoting trolley of FIG. 6.

FIG. 8 is, in perspective view, the pivoting ramp trolley of FIG. 6.

FIG. 9 is, in front elevation view, the ramp and pivoting trolley of FIG. 6.

FIG. 9a is an enlarged partially cut-away view of a portion of FIG. 9.

### DETAILED DESCRIPTION OF EMBODIMENTS OF THE INVENTION

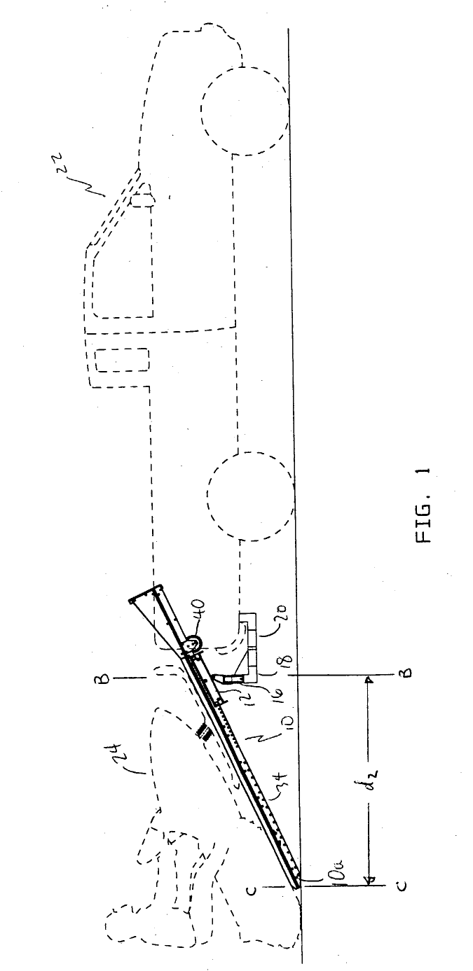

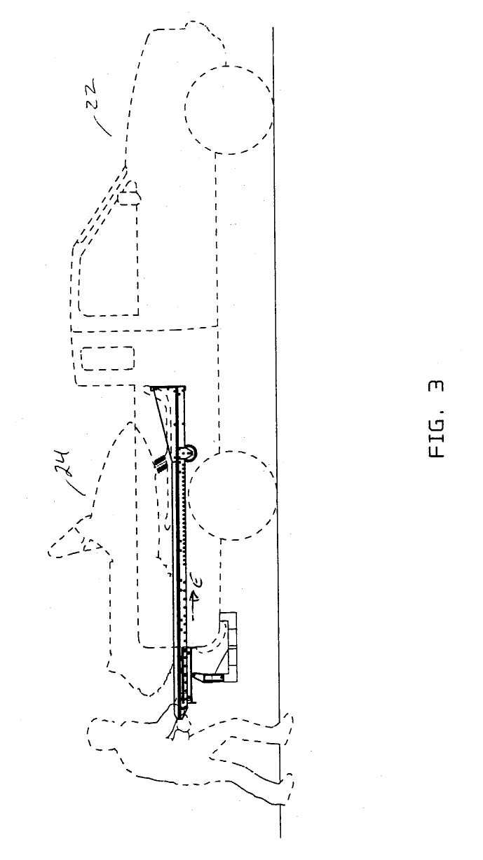

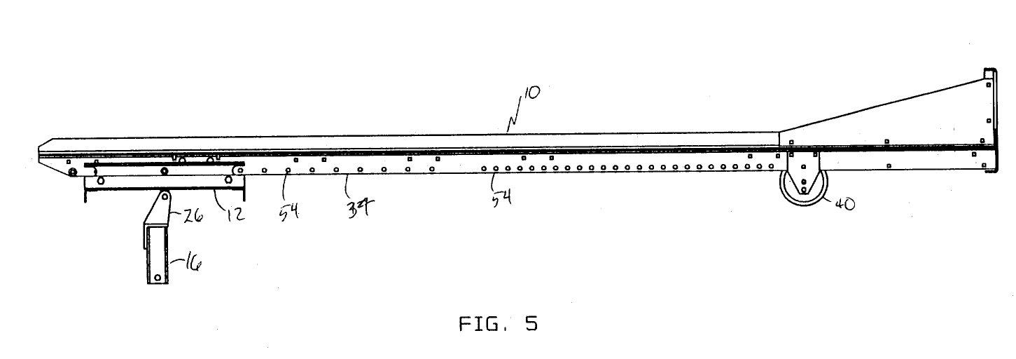

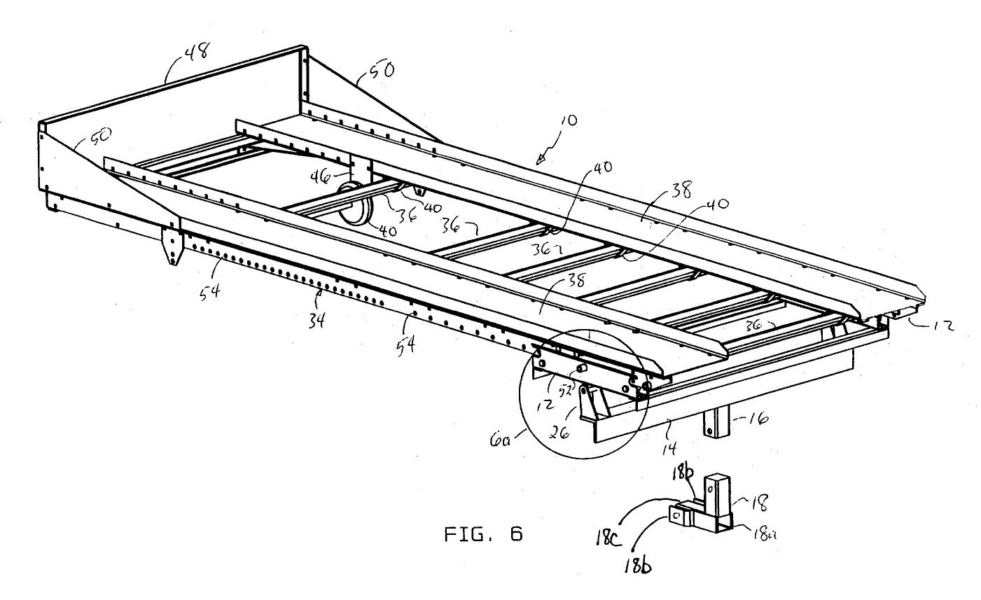

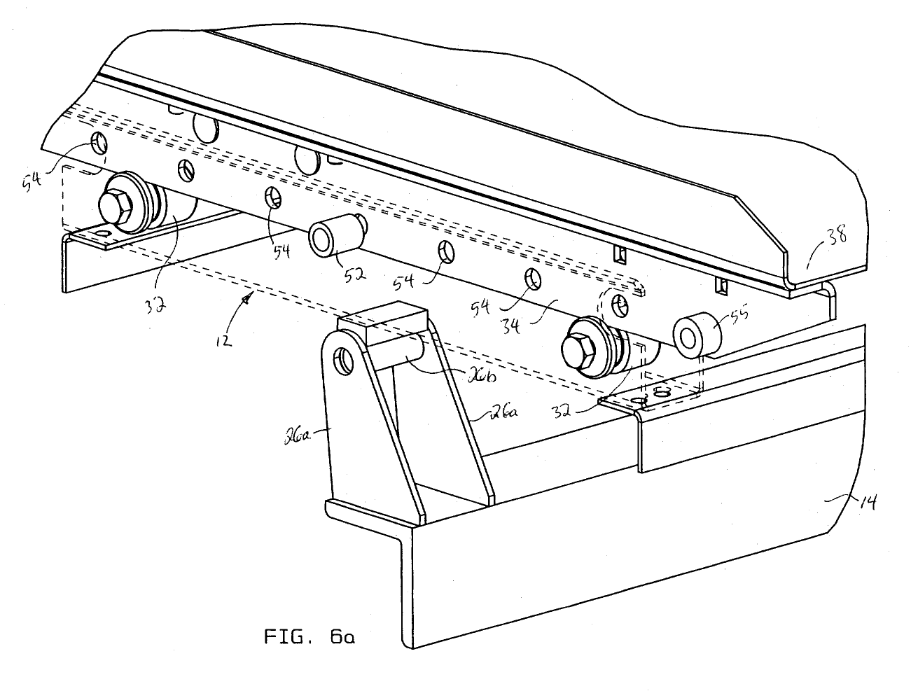

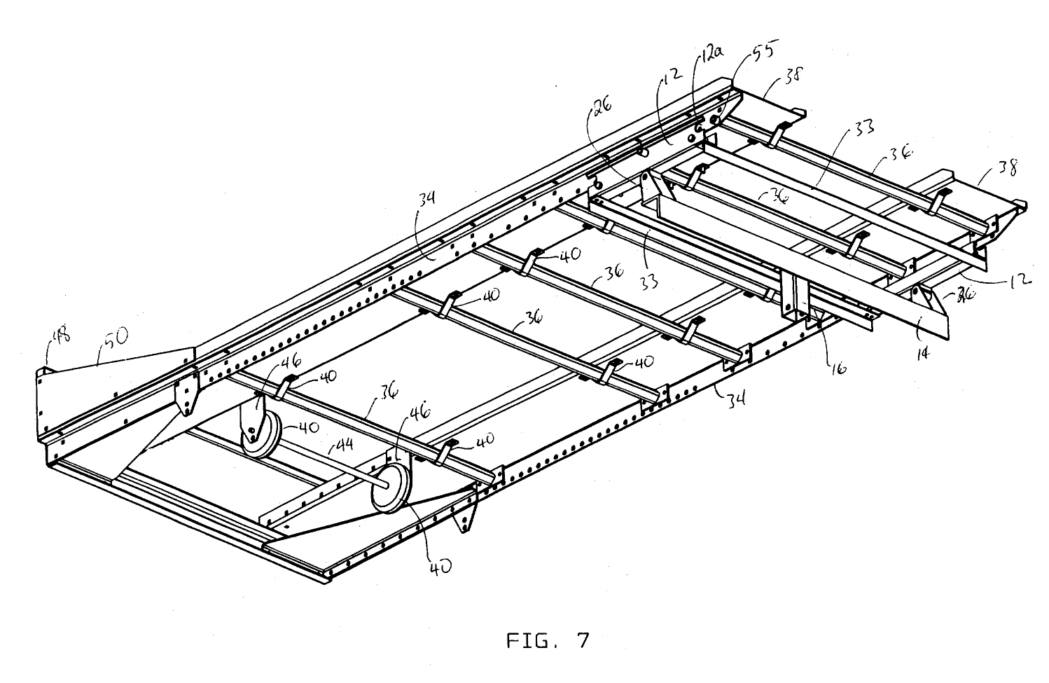

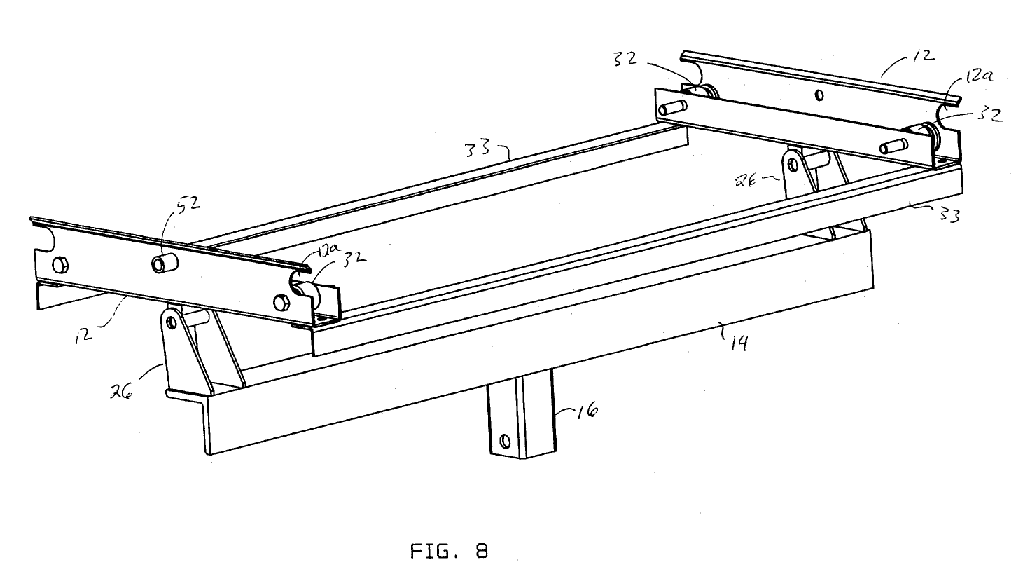

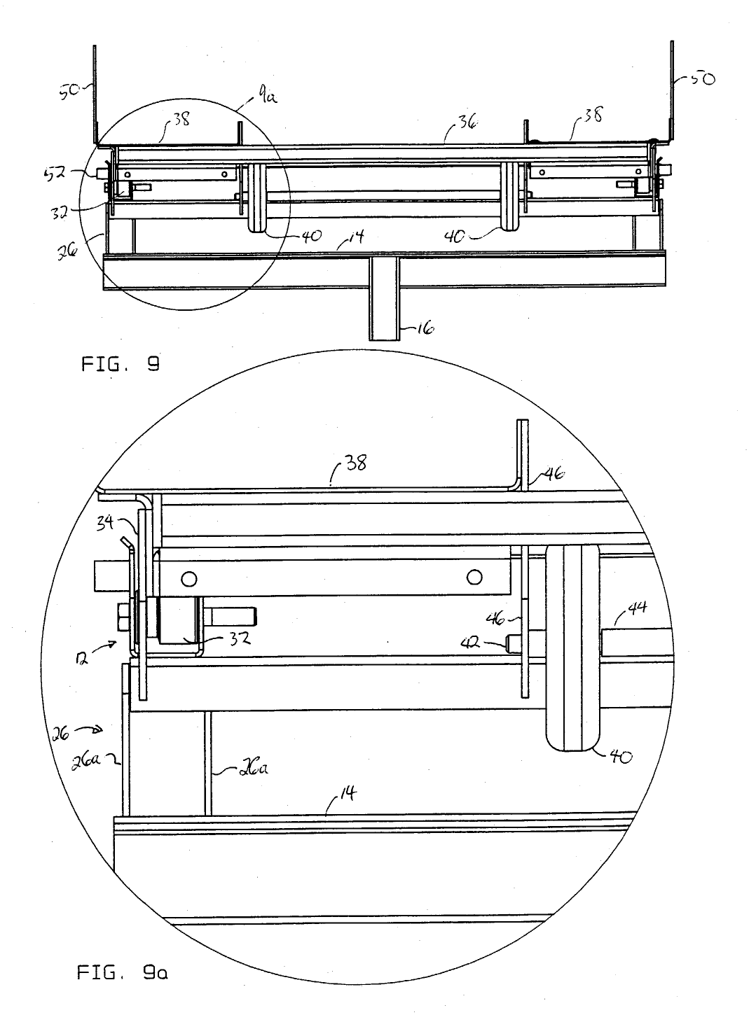

As seen in FIGS. 1-5, the tilting ramp of the present invention pivotally and slidably mounts onto a mounting bracket which itself is mounted into a receiver style hitch on the back of a pickup truck. In particular, ramp 10 is slidably mounted onto roller mounts 12, one on either side of the ramp as better seen in FIGS. 6-9. Roller mounts 12 are pivotally mounted to transverse supporting member 14. Post 16 is rigidly mounted medially along supporting member 14 so as to extend vertically downwardly. Post 16 mounts onto receiver member 18. Receiver member 18 mounts into receiver tube 20, for example, a conventional two inch receiver tube mounted beneath the rear bumper of pickup truck 22. The tailgate of the truck has been removed.

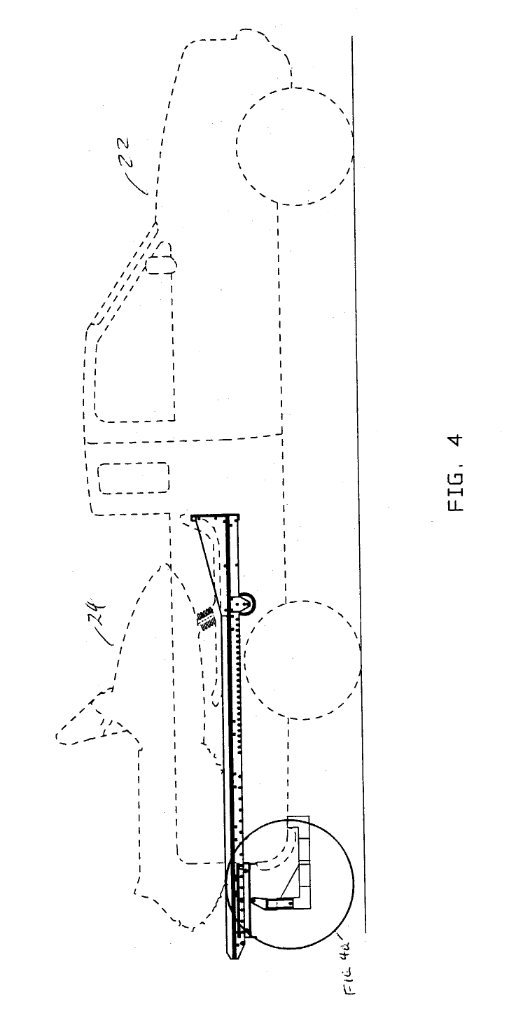

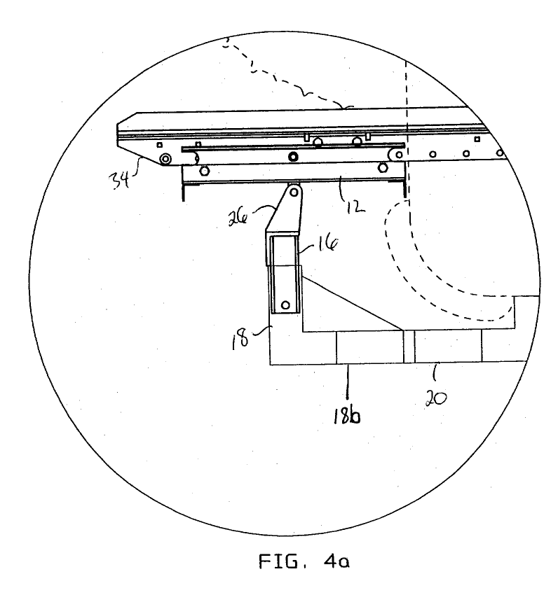

In the lowered position of FIG. 1, ramp 10 is in contact with the ground at its rearward or distal end 10a thereby allowing a personal recreational vehicle such as the snowmobile 24 illustrated to be driven up onto the ramp. Without limiting, personal recreational vehicles are intended to include snowmobiles and all-terrain vehicles. The personal recreational vehicle is driven far enough up onto the inclined ramp so as to position at least part of its weight forward of the fulcrum formed below ramp 10 by the pivoting mount of roller mounts 12 onto supporting member 14 by hinges 26 as better seen in FIGS. 4a and 6a. Hinges 26 may in one embodiment comprise a pair of raised flanges 26a supporting pivot pins 26b.

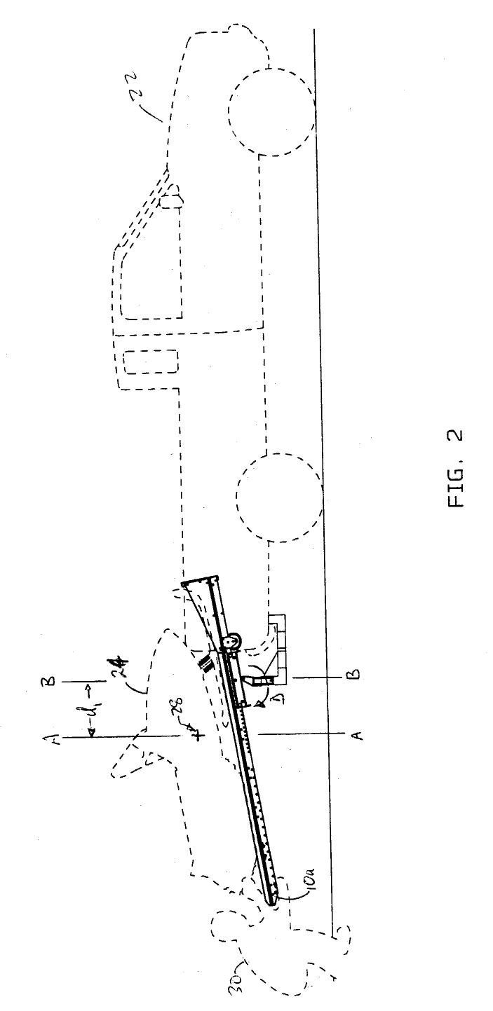

As seen in FIG. 2, the center of gravity 28 of recreational vehicle 24 as illustrated is not intended to be other than an approximating representation of the actual location of the center of gravity of a particular recreational vehicle. A vertical plane A containing center of gravity 28 is horizontally spaced a distance d₁ from a parallel vertical plane B containing the fulcrum or pivot line of hinges 26. Distance d₂, being the horizontal distance between plane B and a vertical plane C through the contact between distal end 10a and the ground, gives a mechanical advantage to a user 30 lifting distal end 10a vertically upwards by the ratio of d₂/d₁. When this ratio is sufficiently large, that is, when center of gravity 28 is positioned relatively close to the fulcrum at hinges 26, a single user 30 may lift the distal end of the ramp with recreational vehicle 24 parked on the ramp so as to rotate the ramp in direction D to the horizontal so that the ramp may be slid horizontally in direction E into the box of the pickup truck.

The use of the receiver hitch tube to mount a fulcrum off the back of the pickup truck allows for rigid positioning of the fulcrum generally in the plane of the bed of the pickup truck box and sufficiently far aft of the bed so as to minimize distance d₁ once recreational vehicle 24 is parked at a relatively easily obtained position on the inclined ramp.

Roller mounts 12 may be sections of channel supporting therein a pair of rotatably mounted nylon rollers 32. The pair of roller mounts may be cross-braced by cross-members 33 rigidly mounted to the roller mounts. A pair of longitudinally extending stringers 34 rigidly mounted on the underside of the ramp in parallel spaced apart array are sized so as to run on rollers 32. Cross members 36 are rigidly mounted to stringers 34 so as to rigidly support runners 38 thereover. Runners 38 may be channel members and, where recreational vehicle 24 is a snowmobile, may be ultra high molecular weight material ski runners. Runners 38 may be mounted to cross members 36 by means of bracing 40.

A pair of wheels 40 are mounted beneath stringers 34 and cross members 36 on axle 42. Wheels 40 are positioned forwardly along stringers 34 so as to be forward of center of gravity 28 of a recreational vehicle 24 when parked on the ramp. Axle 42 is rotatably supported within axle sleeve 44. Wheels 40 extend below stringers 34. They may be mounted so as to depend from the inner sides of runners 38 by mounting brackets 46.

Bulk head 48 is rigidly mounted at the forward end of ramp 10 and supported by bulk head gussets 50.

Sliding forward motion of ramp 10 in direction E so as to roll wheels 40 along the bed of the pickup truck box, or rearward motion of the ramp relative to roller mounts 12 either when loading or once loaded, is arrested by the use of pin locks. In particular, pins 52 in roller mounts 12 insert so as to engage apertures 54. Apertures 54 are formed in spaced apart array along the length of stringers 34. It is understood that the use of pins 52 is not intended to be limiting as other releasable locking devices such as latches may be employed.

In use, receiver member 18 is mounted into receiver tube 20 and post 16 mounted onto receiver member 18. Ramp 10 is placed onto roller mounts 12 so as to engage stringers 34 on rollers 32. Ramp 10 and roller mounts 12 are inclined by pivoting about hinges 26 so as to engage the rearward or distal end 10a of the ramp with the ground. A pair of front pin lock holes of the array of apertures 54, are aligned with pins 52 and the pins inserted into the front pin lock holes so as to lock the position of ramp 10 relative to roller mount 12 during loading of recreational vehicle 24 onto the ramp. The recreational vehicle is then driven onto runners 38 so as to clear distal end 10a of the ramp and the vehicle parked for example by applying its parking brake.

Pin lock pins 52 are then removed and ramp 10 rotated upwardly in direction D until the ramp is horizontal. The ramp is then rolled on wheels 40 and over rollers 32 so as to translate ramp 10 in direction E until bulk head 48 is adjacent or in proximity to the forward end of the pickup truck box. Stops 55 may be provided on stringers 34 so as to engage mating detents 12a in roller mounts 12. Pins 52 are then inserted into a pair of rear pin lock holes, again of the array of apertures 54, so as to lock ramp 10 into the pickup truck box.

When it is desired to unload the recreational vehicle from the pickup truck box, the pins are removed from engagement with the rear pin lock holes and ramp 10 then translated rearwardly until the center of balance is over the fulcrum of hinges 26. Further rearward translation then starts the ramp to tip downwardly as ramp 10 is slid rearwardly out of the box. The rearward end of the ramp is then lowered to the ground and the front pin lock holes engaged by pins 52. The recreational vehicle is then translated rearwardly down the inclined ramp and onto the ground.

In one embodiment, receiver member 18 has a rearwardly opening aperture 18a which is sized to function as an extension of receiver tube 20 so as to allow the male end of a ball hitch to be inserted if the user desires to also tow a trailer.

A pair of generally parallel rigid arms 18b are rigidly mounted on either side of the male mating portion or insert 18c on receiver member 18 which mates into the receiver tube 20 on the pickup truck. Arms 18b mount along the outside, on opposite sides, of receiver tube 20 as male insert 18c mates into receiver tube 20 to provide a means for inhibiting laterally swaying of the ramp due to a loose fit of male insert 18c in receiver tube 20.

Conventionally the male insert of the hitch which fits into the receiver tube is a relatively loose-fit, which is fine if the hitch is merely to be used to provide a ball onto which a trailer is coupled. However, it is not well adapted for a long upstanding support member mounted onto the male insert because the loose fit of the male insert in the receiver tube allows the top of the support member to sway laterally from side-to-side relative to the vehicle. In the present invention the ramp is pivotally mounted onto one such upstanding support member. Consequently in the disclosure as filed, as best seen in FIGS. 6 and 4a, a pair of anti-sway arms 18b couple onto the receiver tube, on either side of the receiver tube, when the male insert 18c of receiver member 18 is inserted into receiver tube 20. The anti-sway arms serve to inhibit lateral swaying of the ramp 10 mounted on top of post 16 and receiver member 18.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A tilting ramp for mounting to a truck, said tilting ramp for loading, unloading and transport of at least one personal recreational vehicle, comprising:
a ramp slidable over a bed of said truck;
a single pivot member mountable into a single center-mounted receiver tube mounted to said truck, said pivot member, when so mounted, extending upwardly into translational engagement with said ramp,
wherein said ramp may be translated over said bed and said pivot member between a transport position forward on said bed and a pivoting position pivotable about said pivot member, said pivoting position pivotable between horizontal and an inclined position in engagement with a ground surface,
said tilting ramp further comprising a pair of generally parallel rigid anti-sway arms rigidly mounted on opposite sides of, and spaced from, a mating portion of said pivot member, said arms for mounting over and onto, along opposite outer sides of, said receiver tube.

2. The tilting ramp of claim 1 wherein said pivot member comprises a mating portion for cantilevered mating into said receiver tube, a riser portion rigidly upwardly extending from, and mounted to, said mating portion, and a pivot mounted atop said riser portion.

3. The tilting ramp of claim 2 wherein said translational engagement of said pivot member with said ramp is rolling cooperation therebetween, at least one roller mounted between said pivot and a corresponding longitudinal member of said ramp.

4. The tilting ramp of claim 3 wherein said ramp is planar and has opposite front and rear ends, and wherein said at least one longitudinal member extends longitudinally between said front and rear ends and depends downwardly from said ramp.

5. The tilting ramp of claim 4 further comprising means for sliding said front end of said ramp over said load receiving bed.

6. The tilting ramp of claim 5 wherein, when said at least one personal recreational vehicle is parked on said ramp, a combined center of gravity of said vehicle and said ramp is proximate to said pivot.

7. The tilting ramp of claim 6 wherein said pivot is at least one pivotable roller mount pivotally mounted atop said riser portion.

8. The tilting ramp of claim 7 wherein said riser portion includes a post and a cross-bar rigidly mounted atop said post, and wherein said at least one longitudinal member is a parallel pair of laterally spaced apart longitudinal members, and wherein said at least one pivotable roller mount is a pair of pivotable roller mounts spaced apart along said cross-bar and correspondingly positioned to said longitudinal members.

9. The tilting ramp of claim 8 wherein rollers are mounted to said roller mounts and said longitudinal members ride on said rollers.

10. The tilting ramp of claim 9 wherein said means for sliding is at least one wheel rotatably mounted toward said front end of said ramp.

11. The tilting ramp of claim 10 wherein said at least one wheel is a laterally spaced apart pair of wheels.

12. The tilting ramp of claim 11 wherein said longitudinal members each have a spaced array of first apertures, and said roller mounts are elongate in a longitudinal direction and have second apertures for pinned releasable locking of said roller mounts to said longitudinal members by pins insertable through aligned first and second apertures.

13. A tilting ramp for mounting to a truck having a load receiving bed and a single center-mounted trailer hitch receiver tube, said tilting ramp for loading, unloading and transport of at least one personal recreational vehicle, said tilting ramp comprising:
(a) a planar ramp having opposite front and rear ends, said ramp including at least one longitudinal member longitudinally extending between said front and rear ends and depending downwardly from said ramp,
(b) a single cantilevered mounting member for cantilevered mounting into said receiver tube, said cantilevered mounting member having a mating portion for mating into said receiver tube, and a riser portion rigidly upwardly extending from, and mounted to said mating portion, and a pivot mounted atop said riser portion,
(c) at least one roller mounted between said pivot and said at least one longitudinal member for rolling cooperation therebetween, and
(d) means for sliding said front end of said ramp over said load receiving bed wherein, when said mating portion is mounted in said receiver tube, said ramp may be slid between a transport position, wherein said rear end is adjacent to said pivot, and a pivoting position wherein, when said at least one personal recreational vehicle is parked on said ramp, a combined center of gravity of said vehicle and said ramp is adjacent to said pivot,
wherein said ramp may be pivoted about said pivot between horizontal and an inclined position engaging said rear end of said ramp with a ground surface,
said tilting ramp further comprising a pair of generally parallel rigid anti-sway arms rigidly mounted on opposite sides of, and spaced from, said mating portion of said cantilevered mounting member, said arms for mounting over and onto, along opposite outer sides of, said receiver tube.

14. The tilting ramp of claim 13 wherein said pivot is at least one pivotable roller mount pivotally mounted atop said riser portion.

15. The tilting ramp of claim 14 wherein said riser portion includes a post and a cross-bar rigidly mounted atop said post, and wherein said at least one longitudinal member is a parallel pair of laterally spaced apart longitudinal members, and wherein said at least one pivotable roller mount is a pair of pivotable roller mounts spaced apart along said cross-bar and correspondingly positioned to said longitudinal members.

16. The tilting ramp of claim 15 wherein rollers are mounted to said roller mounts and said longitudinal members ride on said rollers.

17. The tilting ramp of claim 16 wherein said means for sliding is at least one wheel rotatably mounted toward said front end of said ramp.

18. The tilting ramp of claim 17 wherein said at least one wheel is a laterally spaced apart pair of wheels.

19. The tilting ramp of claim 18 wherein said longitudinal members each have a spaced array of first apertures, and said roller mounts are elongate in a longitudinal direction and have second apertures for pinned releasable locking of said roller mounts to said longitudinal members.

20. A tilting ramp for mounting to a truck having a load receiving bed and a single center-mounted trailer hitch receiver tube, said tilting ramp for loading, unloading and transport of at least one personal recreational vehicle, said tilting ramp comprising:
(a) a planar ramp having opposite front and rear ends, said ramp including at least one longitudinal member longitudinally extending between said front and rear ends and depending downwardly from said ramp,
(b) a single cantilevered mounting member for cantilevered mounting into said receiver tube, said cantilevered mounting member having a mating portion for mating into said receiver tube, and a riser portion rigidly upwardly extending from, and mounted to said mating portion, and a pivot mounted atop said riser portion,
(c) at least one roller mounted between said pivot and said at least one longitudinal member for rolling cooperation therebetween, and
(d) means for sliding said front end of said ramp over said load receiving bed wherein, when said mating portion is mounted in said receiver tube, said ramp may be slid between a transport position, wherein said rear end is adjacent to said pivot, and a pivoting position wherein, when said at least one personal recreational vehicle is parked on said ramp, a combined center of gravity of said vehicle and said ramp is adjacent to said pivot,
wherein said means for sliding said front end of said ramp over said load receiving bed includes rolling means mounted to an underside of said ramp between said front end of said ramp and said pivot,
wherein said ramp may be pivoted about said pivot between horizontal and an inclined position engaging said rear end of said ramp with a ground surface,
said tilting ramp further comprising a pair of generally parallel rigid anti-sway arms rigidly mounted on opposite sides of, and spaced from, said mating portion of said cantilevered mounting member, said arms for mounting over and onto, along opposite outer sides of, said receiver tube.
